(19) United States
(12) Patent Application Publication
(10) Pub. No.: US 2007/0046661 A1
(43) Pub. Date: Mar. 1, 2007

(54) Three or four-dimensional medical imaging navigation methods and systems

(75) Inventors: Qinglin Ma, Bellevue, WA (US); Gianluca Paladini, Skillman, NJ (US); Carol M. Lowery, Issaquah, WA (US); Christopher S. Chapman, Sammamish, WA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/217,211

(22) Filed: Aug. 31, 2005

(51) Int. Cl. G06T 15/00; G09G 5/00

(52) U.S. Cl. 345/419; 345/619

(57) ABSTRACT

Free-hand manual navigation assists diagnosis using perspective rendering for three or four dimensional imaging. In addition to a three-dimensional rendering for navigation, a number of two-dimensional images corresponding to a virtual camera location are displayed to assist the navigation and visualization. Alternatively or additionally, a representation of the virtual camera is displayed in one or more two-dimensional images. The virtual camera is moved within the two-dimensional images to navigate for perspective rendering.

### BACKGROUND

The present embodiments relate to three-dimensional (3D) or four-dimensional (4D) imaging. In particular, navigation is provided for three or four-dimensional imaging.

3D and 4D ultrasound imaging may show a baby face to the parents or provide medical diagnostic information. Two-dimensional arrays allowing real-time 3D (i.e., 4D) imaging provide diagnostic information for cardiologists. Using orthogonal rendering, slices of two-dimensional (2D) images created by a mechanically or electronically scanning probe form a volume. Parallel rays extend through the volume. Data is rendered to a display as a function of the rays. To obtain an aesthetically pleasing volume image, various filtering methods, opacity curves, tint maps and smoothing filtering are provided. The orthogonal rendering creates a fundamental limitation of only allowing the user to view an object from the out side in. Volume editing tools remove a portion of the volume to expose the target object.

However, the current 3D and 4D rendering and display technology may be unwieldy. Multi-planar rendering and associated editing tools expose a region of interest from other scanned regions in a time consuming manner. For example, a face of a fetus may be more easily viewed when the fetus is face up and there is plenty of fluid. First, the sonographer moves the probe while 2D imaging to obtain an image. Second, a volume of interest is placed with the top below the uteral wall. The volume of interest is used to cut away the top uteral wall. The 4D imaging mode then starts. At this point, the baby has not moved so that portions of the head are not clipped. Three orthogonal 2D views through the volume and a rendering are displayed. If the volume of interest tool is not provided, the orthogonal 2D views are rotated and a cut line or plane is manually placed to remove the uteral wall. Once the baby moves, the process is repeated. The majority of the time for an exam is spent to chase the movement of the baby and place the volume of interest for volume editing. Using available editing tools to remove data associated with the wall but maintain data associated with the fetus may require a long learning curve and slow down workflow.

The editing tools may not be able to provide some desired views, such as an internal tunnel view of the plaque inside a blood vessel and the heart valve or wall from inside the chambers. Without a complicated editing tool, a parallel plane in front of a mitral valve clips data. However, a more involved view by rendering from within the chambers may not be provided.

A user may view images from inside the body cavity with perspective rendering using ultrasound data. However, navigation is difficult or not provided. Computed tomography and magnetic resonance imaging use fly-through renderings for colon examination. However, the navigation of the camera is exclusively through volume the rendered image. Any multi-planar renderings correspond to the patient or scanning system orientation, and the navigation is limited to a predetermined path.

### BRIEF SUMMARY

By way of introduction, the preferred embodiments described below include methods, systems and computer readable media for three or four-dimensional imaging navigation. Free-hand manual navigation of perspective rendering is provided. A two-dimensional image corresponding to a virtual camera location is also displayed to assist the navigation. Alternatively or additionally, one or more two-dimensional images display a representation of the virtual camera. The virtual camera moves within the two-dimensional images or the volume image to navigate for perspective rendering.

In a first aspect, a method is provided for three or four-dimensional imaging navigation. A medical image is perspective three-dimensional rendered from a virtual camera within a scanned volume. A position of the virtual camera within the scanned volume is controlled by manual free-hand input. At least one two-dimensional medical image is displayed as a function of the position.

In a second aspect, a method is provided for three or four-dimensional imaging navigation. A virtual camera changes from a first location within a scanned volume to a second location. For each of the first and second locations, two-dimensional medical images corresponding to a plurality of two-dimensional planes in the scanned volume are generated. The plurality of two-dimensional planes intersects the first or second locations of the virtual camera within the scanned volume.

In a third aspect, a computer readable storage medium has stored therein data representing instructions executable by a programmed processor for navigating in medical imaging. The instructions include: perspective three-dimensional rendering a medical image from a virtual camera within a scanned volume, moving the virtual camera within the scanned volume by manual input, and generating a two-dimensional image as a function of the moving virtual camera.

In a fourth aspect, a computer readable storage medium has stored therein data representing instructions executable by a programmed processor for navigating in medical imaging. The instructions include: moving from a first location of a virtual camera within a scanned volume to a second location, and generating, for each of the first and second locations, two-dimensional medical images corresponding to a plurality of two-dimensional planes in the scanned volume, the two-dimensional planes altering position to intersect the virtual camera within the scanned volume throughout the movement of the virtual camera.

The following claims define the present invention, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of one embodiment of a method for three or four-dimensional navigation in medical imaging;

FIG. 2 is a graphical representation of perspective rendering;

FIG. 3 is a graphical representation of one embodiment of a display of 3D or 4D and multi-planar rendering;

FIG. 4 is an illustration of one embodiment of a user interface for navigation; and

FIG. 5 is a block diagram of one embodiment of a medical diagnostic ultrasound imaging system and computer readable media for three or four-dimensional navigation.

### DETAILED DESCRIPTION OF THE DRAWINGS AND PRESENTLY PREFERRED EMBODIMENTS

A user navigates a virtual camera through and inside a body cavity. The method uses planar or three-dimensional rendering for navigation, reducing editing. The navigation is intuitive, accelerating the workflow. Different views may be provided, such as perspective views of different parts of a cavity. An ultrasound system, medical imaging system or a computer implements the navigation, such as an imaging system providing navigation during live scanning or during post processing of a 3D or 4D volume. The system allows free hand positioning. The planar images correspond to the camera location, allowing the user to interact with the camera on the planar images with feedback in the 3D or 4D images. The perspective rendering is alternatively used for navigation.

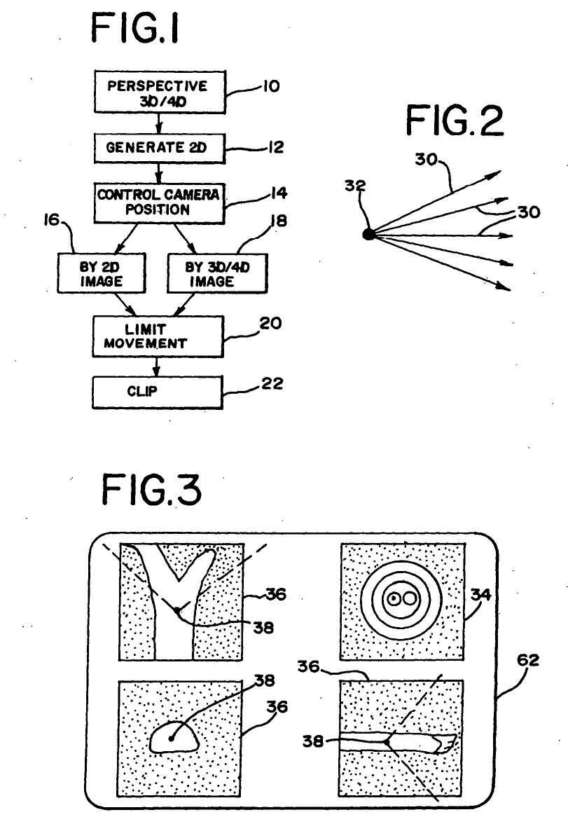

FIG. 1 shows a method for three or four-dimensional imaging navigation. The method uses the systems or instructions described below, but other systems or instructions may be used. The method may provide additional, different or fewer acts. For example, the method implements without acts 10, 16, 18, 20, and/or 22. The method may include navigation with planar images with or without perspective rendering. The method may include perspective volume rendering with or without navigation using planar images. Other sequences of the acts than shown in FIG. 2 may be used.

In act 10, a perspective three-dimensional medical image is rendered from a virtual camera within a scanned volume. Data representing the scanned volume is acquired and used in real-time or acquired and stored for later use. The data represents different scan lines, planes or other scan formats within the volume. The data is formatted based on the scan or reformatted into a three-dimensional data set.

A single data set represents the volume at a substantially same time. For three-dimensional rendering, a single data set is used. For four-dimensional imaging, a sequence of three-dimensional renderings is rendered from a plurality of data sets as a function of time. Each three-dimensional image is a representation of the volume displayed on a two-dimensional display. For four-dimensional imaging, the renderings are performed in real-time with acquisition or as a post process from a stored sequence of data sets.

FIGS. 2 and 3 show perspective three-dimensional rendering of a three-dimensional image 34. Ray lines 30 extend from a position 32 of a virtual camera. The ray lines 30 diverge from the position 32 over a field of view. The user or a processor selects the field of view. The field of view is 90 degrees pyramid or cone in one embodiment, but may have other extents or shapes. The field of view covers or extends through a subset of the data representing the scanned volume.

The data along the ray lines 30 determines the pixel values for the three-dimensional image. Maximum, minimum, average, or other projection rendering techniques may be used. Shading, opacity control or other now known or later developed volume rendering effects may be used. Alternatively, surface rendering from a perspective view is provided, such as surface rendering within the field of view defined by the extent of the ray lines 30. Rather than rendering one three-dimensional image for the position 32, two three-dimensional medical images are rendered. By using two sets of ray lines 30 offset from each other, the rendering is in stereo. Stereo views may enhance depth perception, making the 3D navigation more intuitive. Whether stereo or not, the perspective three-dimensional rendered image 34 appears as a picture seen through the virtual camera viewing window. The closer the image or images structure to the camera, the larger the structure appears.

The rendering occurs as a function of time. For example, a static or signal set of data represents a scanned volume. As the user navigates, repositioning the virtual camera into different locations, different renderings result. As another example, different renderings result from different data sets with or without repositioning the virtual camera. The renders result from imaging a sequence.

Perspective rendering for three or four-dimensional imaging may provide depth perception since the size of an image or imaged structure is proportional to the relative location to the virtual camera. Since only data in the field of view is used, the rendering may be fast. By rendering from the position 32 within a cavity, any need for editing may decrease. Different viewing positions or angles are possible without additional manual editing since the field of view automatically selects appropriate data.

A medical image is rendered. The image is of a patient, such as rendering from a scan of an interior volume of a patient. Ultrasound, x-ray, magnetic resonance, positron emission, combinations thereof, or other medical scanning energy is used. For example, a three-dimensional ultrasound image represents a vessel or heart. The position 32 is within the vessel or heart. The three-dimensional image 34 of FIG. 3 represents the position 32 in a carotid artery at bifurcation. The volume rendered and viewed in this way places the user inside the vessel. By moving the position 32 of the virtual camera, the user may obtain any desired viewing angle of the vessel, fly through the vessel, or exam different parts of the heart or other cavity.

In act 12 of FIG. 1, one or more two-dimensional images 36 (see FIG. 3) are generated. The two-dimensional images 36 correspond to respective two-dimensional planes in the scanned volume. For example, three two-dimensional images 36 correspond to two or three orthogonal planes through the volume. The data in the scanned volume intersecting the plane or adjacent to the plane is selected and used to generate a two-dimensional image 36. Other multi-planar renderings may be used with or without orthogonal or perpendicular planes.

The two-dimensional planes intersect the position 32 of the virtual camera used for the three-dimensional rendering of act 10. A processor automatically positions the planes to include the current position 32. As the virtual camera changes locations or alters position, the location of the planes within the scanned volume changes to maintain the intersection throughout movement of the virtual camera. The update rate of plane positions is the same or different from the update rate of positioning of the virtual camera. One or more planes and associated images not intersecting the current position 32 of the virtual cameral may be provided.

The two-dimensional image or images 36 are displayed substantially simultaneously with the three-dimensional medical image 34. The update or refresh rate of the different images may be different, but the user sees the images at generally a same time. As shown in FIG. 3, three two-dimensional images 36 corresponding to three orthogonal planes intersecting a position 32 of the virtual camera are displayed at a same time as the three-dimensional rendered image 34. The images 34, 36 are oriented relative to the position 32. Any arbitrary translation or rotation of the three two-dimensional planes may be used, such as a transducer-based orientation. In the example of FIG. 3, the user or a processor orients two planes to provide longitudinal cross sections of a vessel and another plane to be a transverse cross section of the vessel. As the position 32 changes, the same orientation is used, the orientation updates based on the structure, or the orientation updates based on user adjustment.

The two-dimensional images 36 include a representation 38 of the position 32 of the virtual camera. One, more, or all of the two-dimensional images 36 include the representation 38. Any representation may be used. In FIG. 3, the representation is a dot, such as a dot colored to provide contrast within the images 36. A camera icon, an intersection of lines, an arrow or other representation may be used. The representation 38 indicates the position 32 to the user. The representation includes or does not include additional graphics in other embodiments. For example, dashed lines or a shaded field represents the field of view.

In act 14, the method provides different options for controlling the position 32 of the virtual camera. Two different options are shown associated with acts 16 and 18, but only one, three or more control options may be provided.

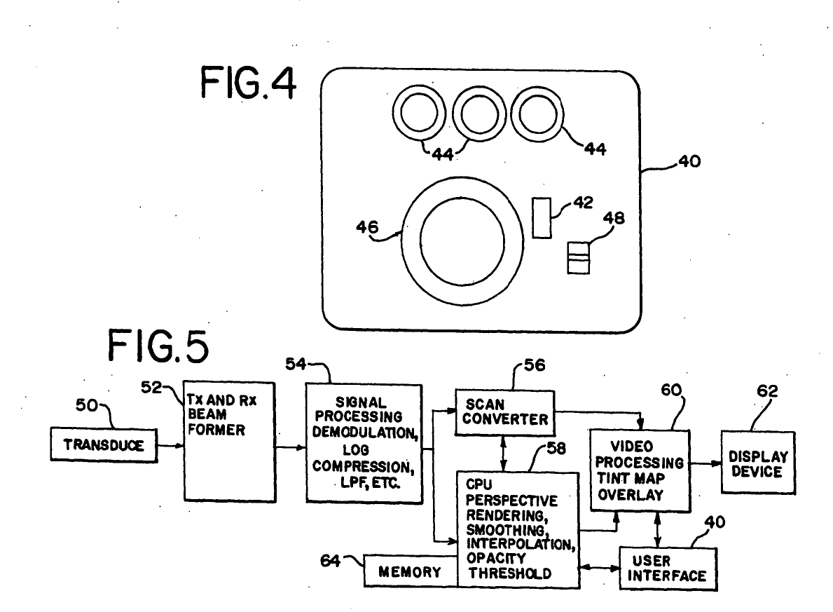

With more than one option, the user selects between the options, a default option is used or other selection occurs. For example, FIG. 4 shows one embodiment of a user input 40. A button 42 or other user input arbitrates between the two options, such as navigation of the virtual camera using the three-dimensional image 34 or using the two-dimensional images 36. The same controls, such as rotatable knobs 44, track ball 46, biased switch 48 may be used for pan, zoom, or rotation. Different controls, such as a mouse, sliders, touch screen, keys, touch pad, joystick, voice control or combinations thereof may be used. As another example, different controls are used for the different options. As yet another example, the location of a cursor controlled by the track ball 46 and positioned over one of the types of images 34, 36 selects a type of navigation.

In addition to type of navigation, the user input 40 may include additional functions, controls or both for implementing other changes. For example, the user input 40 is used to configure an ultrasound system or a computer. As another example, the user input 40 provides other navigation related controls different for or common to the different types of navigation. The user may change the field of view or the depth of the viewing field. The user may flip the camera-viewing window vertically or horizontally, shifting every 90 degrees, or other controls for enhanced workflow. Any now known or later developed navigation tools may be used.

The navigation controls operate for a static data set, for a sequence of medical images or for real time imaging. For example, during imaging of a sequence of scanned volume, the position 32 moves or stays in a same location between images or data sets as a function of time.

In act 18, the position 32 of the virtual camera is controlled with respect to the perspective three-dimensional rendered medical image 34. Manual input on the user input 40 moves the virtual camera within the scanned volume. The position 32 may be translated, rotated, zoom or combinations thereof. For example, the track ball 46 is used forward, backward, left and right movement. The biased three-position switch 48 is used for up and down movement. Three different rotatable knobs 44 are used for rotation along three different axes. Using these or other user inputs, the user manually controls the position by free-hand input. The three-dimensional medical image 34 updates or is re-rendered as the position 32 changes, providing feedback to the user. The position of the representation 38 in the two-dimensional image or images 36 also updates or is altered as the position 32 changes.

In act 16, the representation 38 in at least one of the two-dimensional images 36 controls the position 32 of the virtual camera. The virtual camera changes or moves from one location to another location within the scanned volume. The change is in response to the user moving the representation 38 by manual free-hand input. Using the user input 40, the angle of the representation 38 (rotation) changes and/or the representation 38 translates. By selecting in which two-dimensional image 36 to move the representation, six degrees of freedom of movement (three rotations and three translations) of the position 32 may be used. The knobs 44, track ball 46, biased switch 48 or other controls move the representation. For example, the user selects a two-dimensional image 36 or controls associated with a specific two-dimensional image 36 and moves the representation 38 with the controls. Alternatively, the user clicks and drags the representation 38 on the screen.

For example and as shown in FIG. 3, a green dot (the representation 38) represents the virtual camera on three two-dimensional images 36 associated with orthogonal planes. The intersection of the three orthogonal multi-planar rendering is the position 32. Green lines extend from the representation 38 and show the direction at which the camera is pointing, the size of the field of view, and the depth of the viewing field. The user may manipulate the image or the camera location and orientation. The movement of the camera is straight or curved or any way the user desires.

Synchronization between images 34, 36 may provide real-time feedback for the user. Movement of the position 32 in any image 34, 36 moves the representation 38 and associated rendering in other images 34, 36. The three-dimensional image 34 renders in response to each new position 32. The two-dimensional images 36 generate in response to each new position 32. Alternatively, the position 32 stays in a same location or within a same plane relative to one or two of the two-dimensional images 36. The two-dimensional images 36 may stay the same with only the position of the representation 38 updated. The two-dimensional images 36 may update even though being in a same plane as previously to center the representation 38.

Free-hand navigation allows movement of the position 32 wherever desired by the user, including within or outside of a cavity or the scanned volume. In an alternative embodiment provided by act 20, the virtual camera moves within a boundary, limiting movement outside of the boundary. Thresholding, gradients, derivatives, boundary segmentation, or other functions automatically identify one or more boundaries. Alternatively, the user identifies the boundary manually or assists an automatic process. Once identified, the position 32 is restricted to be within the boundary, such as the surface of the cavity (e.g., vessel or heart walls). For a boundary extending to an edge of the scanned volume, the position 32 is limited to within the scanned volume or is allowed to be at a location outside of the scanned volume. Maintaining the position 32 within a fluid filled cavity may avoid blind views or views rendered with opaque tissue at the virtual camera.

In act 22, navigation with perspective rendering allows clipping of data in a user intuitive manner without complicated editing tools. While viewing or navigating, the user selects clipping. For example, the user depresses a button while the virtual camera is at one location. A processor receives a clipping indication. The position 32 defines, in part, the field of view. The processor maintains the locations of the scanned volume within the field of view and removes or does not further use other locations for subsequent rendering. Alternatively, the viewing direction defines an orthogonal plane through the position. The processor maintains data on the viewing direction side of the plane and does not use data in the opposite direction. Other position based clipping may be used.

The position 32 of the virtual camera moves, such as moving generally backwards are away from the previous field of view. As the position 32 changes locations, the processor perspectively renders three-dimensional images 34 from the limited or clipped data set. The two-dimensional images 36 include data from the entire data set or scanned volume or only include data after clipping.

Clipping may remove data associated with a blocking or interfering object. For example, the virtual camera moves past an object of no interest to view an object of interest. By activating the clipping, the processor removes data of the object of no interest in the scanned volume. Subsequent three-dimensional renderings may not include the object of no interest for any position 32 of the virtual camera. When the virtual camera backs up, there is no undesired tissue cluttering the three-dimensional image 34. The perspective image 34 looks more natural when the virtual camera is located away from the target.

The navigation herein may simplify volume editing, providing the desired three-dimensional image faster. Many medical applications may more conveniently use 3D and 4D ultrasound imaging. For OB examination, very often the fetus has as least one limb placed right in front of its face. To view the entire face, the virtual camera is placed at an angle that avoids the limb for a perspective rendering. Clipping may also be used. For vascular examination, the virtual camera flies-through the inside of a vessel. The resulting three-dimensional perspective rendered image may show any diseased vessel, plaque, clod, suture, graph, by-pass, or other structure from inside out.

For cardiac imaging, the virtual camera inside any heart chamber examines the valve movement and wall motion. For contrast study, the virtual camera monitors the process from inside the vessel or the heart. For GYN applications, the virtual camera inside the tube examines the follicles and allows counting of the mature eggs. The virtual camera inside the uterus monitors the ovulation process, examines any growth such as tumor or cancer, or examines the endometrial cavity. For Neo-natal brain applications, the virtual camera inside the ventricle examines the morphology and clot.

For abdomen applications, the virtual camera inside the gallbladder examines the gallstones. For urology application, the virtual camera inside the bladder examines functionality and abnormities, such as the polyps. For ocular or orbital imaging, the virtual camera exams whether there is a tear of retina and the severity. The navigation assists these or other applications.

The navigation may include additional features, such as allowing efficient rotation of the images. The user chooses a point in the three-dimensional rendered image as a pivot point. For example, the user uses the trackball or mouse to click on the four-dimensional image to choose a point. The point is attached to the nearest surface of the imaged object in the three-dimensional image (e.g., behind the selected point along a same ray or pixel location). A green dot or other marker is displayed on the thee-dimensional image to show the pivot point. The user may navigate as discussed herein, resulting in the marker moving with the identified point relative to the virtual camera. Once a rotation mode is activated, operating a knob, slider, trackball or other user input rotates the three-dimensional image about the pivot point. The associated two-dimensional images may change as a function of the rotation wherein the virtual camera also rotates about the pivot point. The user may assign each pivot point a name and include the pivot points in a marker list. Later, by clicking on the name from the list, the system adjusts the virtual camera and/or image selection to display the marker immediately, allowing entering of annotations, saving images for that marker and/or entering images into the patient report.

FIG. 5 shows one embodiment of a system and associated computer readable storage medium for navigating in medical ultrasound imaging. FIG. 5 shows implementation of the method or other navigation on a medical ultrasound acquisition and imaging system. Other medical acquisition systems may be used, such as computed tomography, magnetic resonance, positron emission or other imaging systems. The system may include additional, different or fewer components.

A transmit beamformer 52 controls a transducer 50 to generate acoustic energy. The receive beamformer 52 generates samples or data representing scanned spatial locations. The transmit and receive beamformer 52 and transducer 50 mechanically or electrically scan a volume of interest. A signal processor 54 demodulates and log compresses the data. The signal processor 54 implements detection, such as B-mode, flow-mode or Doppler detection. Other signal processes may be implemented, such as low pass temporal or spatial filtering. A processor 58 uses the data in an acquisition format or a display format output by a scan converter 56. The processor 58 performs perspective rendering. The processor 58 may provide smoothing, interpolation to a three-dimensional grid, opacity control, shading, thresholding or other rendering options. The processor 58 outputs a three-dimensional rendered image 34 for display on the display 62. The scan converter 56 outputs two-dimensional images 36. The processor 58 may also or alternatively outputs two-dimensional images 36, such as associated with multi-planar rendering through the scanned volume. The video processor 60 combines the information for display, such as providing quadrants for different images and overlaying any text or the representation 38. The processor may be a CPU as shown or a GPU, DSP, ASIC, general processor, FPGA or any other now known or later developed device.

The user input 40 controls the navigation and associated rendering by the processor 58 and/or video processor 60. The user input 40 interfaces with the ultrasound system through a USB port, fire wire, serial port, parallel port or other connectors. The user input 40 uses hard keys, soft keys, tough panel, voice control, trackball, cine wheel, push keys, knobs, rotational buttons, key board, joystick or other devices for navigation.

In alternative embodiments, the system is a computer, personal computer, laptop, DICOM workstation or other workstation. For example, a desktop application processes medical data or ultrasound volumes offline. The offline processing unit receives ultrasound 3D or 4D volumes. Offline volume processing software manipulates the volume for navigation and rendering as discussed herein. For desktop application, a 3D joystick, keyboard, mouse or similar device may control navigation.

A memory 64 stores the data sets representing the scanned volume and/or instructions for implementing the rendering and navigation. The memory 64 is a computer readable storage medium having stored therein data representing instructions executable by the programmed processor 58 for navigating in medical imaging. The instructions implement the processes, methods and/or techniques discussed above. The memory 64 is a computer-readable storage media or memory, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method for three or four-dimensional imaging navigation, the method comprising:
perspective three-dimensional rendering a medical image from a virtual camera within a scanned volume;
controlling a position of the virtual camera within the scanned volume by manual free-hand input; and
displaying at least one two-dimensional medical image as a function of the position.

2. The method of claim 1 wherein controlling the position by manual free-hand input comprises changing the position in response to user indication of a direction of translation, rotation or translation and rotation.

3. The method of claim 1 wherein perspective three-dimensional rendering comprises rendering as a function of time and wherein controlling comprises controlling through a sequence of medical images including the medical image.

4. The method of claim 1 wherein perspective three-dimensional rendering from a virtual camera comprises rendering as a function of ray lines extending from the position of the virtual camera.

5. The method of claim 1 wherein perspective three-dimensional rendering the medical image comprises rendering an ultrasound image of a vessel or heart, the position being within the vessel or heart.

6. The method of claim 1 wherein displaying comprises generating at least three two-dimensional images corresponding to a respective at least three two-dimensional planes in the scanned volume, the two-dimensional planes intersecting the position of the virtual camera within the scanned volume.

7. The method of claim 6 further comprising:
providing at least first and second options for controlling the position of the virtual camera, the first option being controlling the position with respect to the perspective three-dimensional rendered medical image and the second option being controlling the position of a representation of the virtual camera in at least one of the two-dimensional images.

8. The method of claim 1 further comprising:
limiting movement of the virtual camera as a function of a boundary in the scanned volume.

9. The method of claim 1 wherein perspective three-dimensional rendering comprises rendering along a field of view as a function of the position, the field of view covering a subset of the scanned volume;
further comprising:
receiving a clipping indication;
moving the position of the virtual camera away from the subset;
perspective three-dimensional rendering another medical image from a portion of the scanned volume limited by the position of the virtual camera when the clipping indication is received.

10. The method of claim 9 wherein both perspective three-dimensional rendering acts are of a first object located behind a second object, both the first and second objects being within the scanned volume, the other medical image including the first object and not the second object.

11. A method for three or four-dimensional imaging navigation, the method comprising:
changing from a first location of a virtual camera within a scanned volume to a second location; and
generating, for each of the first and second locations, two-dimensional medical images corresponding to a plurality of two-dimensional planes in the scanned volume, the plurality of two-dimensional planes intersecting the first or second locations of the virtual camera within the scanned volume.

12. The method of claim 11 wherein changing from the first location to the second location comprises controlling a position of a representation of the virtual camera in at least one of the two-dimensional images.

13. The method of claim 11 wherein changing comprises controlling a position of the virtual camera within the scanned volume by manual free-hand input.

14. The method of claim 11 wherein the plurality of two-dimensional planes comprises at least two orthogonal planes, the corresponding two-dimensional images each including a representation of a position of the virtual camera, and wherein changing comprises changing an angle, translating, or changing an angle and translating the representation.

15. The method of claim 11 further comprising:
perspective rendering a three-dimensional medical image from the first and second locations of the virtual camera within the scanned volume, the three-dimensional medical image displayed substantially simultaneously with the two-dimensional medical images.

16. The method of claim 15 further comprising:
providing at least first and second options for controlling a position of the virtual camera, the first option being controlling the position with respect to the perspective rendered three-dimensional medical image and the second option being controlling the position of a representation of the virtual camera in at least one of the two-dimensional medical images.

17. The method of claim 15 wherein perspective rendering comprises rendering along a field of view as a function of the first location, the field of view covering a subset of the scanned volume;
further comprising:
receiving a clipping indication while the virtual camera is at the first location;
after changing to the second location, perspective rendering another three-dimensional medical image from a portion of the scanned volume limited by the first location of the virtual camera.

18. The method of claim 11 wherein changing and generating comprise changing and generating through a sequence of data.

19. The method of claim 11 wherein generating the two-dimensional medical images comprises generating ultrasound images of a vessel or heart, the first and second locations being within the vessel or heart.

20. The method of claim 11 further comprising:
limiting movement of the virtual camera as a function of a boundary in the scanned volume.

21. In a computer readable storage medium having stored therein data representing instructions executable by a programmed processor for navigating in medical imaging, the storage medium comprising instructions for:
perspective three-dimensional rendering a medical image from a virtual camera within a scanned volume;
moving the virtual camera within the scanned volume by manual input; and
generating a two-dimensional image as a function of the moving virtual camera.

22. The instructions of claim 21 wherein perspective three-dimensional rendering the medical image comprises rendering an ultrasound image of a vessel or heart, the virtual camera being within the vessel or heart.

23. The instructions of claim 21 wherein generating comprises generating a plurality of two-dimensional images corresponding to a respective plurality of two-dimensional planes in the scanned volume, the two-dimensional planes altering position to intersect the virtual camera within the scanned volume throughout the movement of the virtual camera.

24. The instructions of claim 21 further comprising:
identifying a point in the medical image; and
rotating the medical image about the point.

25. In a computer readable storage medium having stored therein data representing instructions executable by a programmed processor for navigating in medical imaging, the storage medium comprising instructions for:
moving from a first location of a virtual camera within a scanned volume to a second location; and
generating, for each of the first and second locations, two-dimensional medical images corresponding to a plurality of two-dimensional planes in the scanned volume, the two-dimensional planes altering position to intersect the virtual camera within the scanned volume throughout the movement of the virtual camera.

26. The instructions of claim 25 wherein moving from the first location to the second location comprises controlling a position of a representation of the virtual camera in at least one of the two-dimensional images.

27. The instructions of claim 25 wherein generating comprises generating the two-dimensional images where the plurality of two-dimensional planes comprises at least two orthogonal planes, the corresponding two-dimensional images each including a representation of a position of the virtual camera, and wherein moving comprises changing an angle, translating, or changing an angle and translating the representation.

28. The instructions of claim 25 further comprising:
perspective rendering a three-dimensional medical image from the first and second locations of the virtual camera within the scanned volume, the three-dimensional medical image displayed substantially simultaneously with the two-dimensional medical images.
